(19) United States
(12) Patent Application Publication
(10) Pub. No.: US 2020/0018277 A1
(43) Pub. Date: Jan. 16, 2020

(54) Fuel Supply System And Fuel Distributor Block

(71) Applicant: MAN Energy Solutions SE, Augsburg (DE)

(72) Inventors: Ümit Bozkurt, Augsburg (DE); Christian Monzert, Augsburg (DE)

(21) Appl. No.: 16/464,945

(22) PCT Filed: Sep. 14, 2017
(86) PCT No.: PCT/EP2017/073164

§ 371 Date: May 29, 2019

(30) Foreign Application Priority Data
Nov. 30, 2016 (DE) 10 2016 123 055.3

(51) Int. Cl. F02M 63/02; F02M 65/00; F02D 41/22

(52) U.S. Cl. CPC F02M 63/027; F02D 2041/225; F02D 41/22; F02M 65/006

(57) ABSTRACT

A fuel supply system, having a low-pressure region, a high-pressure region, a pumping device, a low-pressure pump, and a high-pressure pump A pressure accumulator system is provided between the pumping device and injectors and has distributor units. Between the low-pressure pump and the high-pressure pump, a fuel distributor block is provided, which has a fuel leakage collection line for fuel leakage supplied to the fuel distributor block that has a choke and a bypass around the choke and a leakage sensor in the bypass. The choke is dimensioned such that all fuel leakage flows through the choke if the fuel leakage conducted via the fuel leakage collection line is less than a limit value, and fuel leakage flows through the bypass and across the leakage sensor if the fuel leakage conducted via the fuel leakage collection line is greater than the limit value.

### CROSS-REFERENCE TO RELATED APPLICATIONS

This is a U.S. national stage of application No. PCT/EP2017/073164, filed on Sep. 14, 2017. Priority is claimed on German Application No. DE102016123055.3, filed Nov. 30, 2016, the content of which is incorporated here by reference.

### BACKGROUND OF THE INVENTION

### 1. Field of the Invention

The invention relates to a fuel supply system of an internal combustion engine and a fuel distributor block for a fuel supply system.

### 2. Description of the Prior Art

From DE 10 2013 000 606 A1 the fundamental construction of a common-rail fuel supply system of an internal combustion engine is known, namely a diesel internal combustion engine operated with heavy fuel oil is known. Accordingly, the common-rail fuel supply system of FIG. 1 comprises at least one injector for each cylinder of the internal combustion engine. By way of the injectors, fuel is injectable into each of the cylinders of the internal combustion engines. The common-rail fuel supply system, furthermore, comprises at least one low-pressure pump, at least one high-pressure pump, and a high-pressure pump accumulator, in order to convey fuel from a low-pressure region of the common-rail fuel supply system into a high-pressure region of the same in the high-pressure region between the pumping device and the injectors a pressure accumulator system is provided that is permanently under high pressure. The pressure accumulator system that is permanently under high pressure, which is also referred to as common rail, comprises multiple distributor units. The distributor units are connected to the pumping device and interconnected by way of high-pressure lines that are permanently under high pressure. The pressure accumulator system, namely the distributor units, are, furthermore, connected to the injectors by way of high-pressure lines which, dependent on the injection cycle, are under high pressure at times. The high-pressure lines which, dependent on the injection cycle, are under high pressure at times, which connect the injectors to the distributor units, are assigned switching valves which, dependent on the injection cycle, feed fuel to the injectors.

Such a fuel supply system of an internal combustion engine known from the prior art comprises a multiplicity of sealing points in the high-pressure region, in particular in the region of the pressure accumulator system, which comprises the distributor units, that are coupled by way of the high-pressure lines. In the region of these sealing points, leaks can occur wherein in particular when a leakage quantity becomes too great, a proper operation of the fuel supply system can no longer be ensured. Furthermore, the high-pressure lines as such can be damaged, by way of which an impermissibly high leakage can likewise be caused. It is known to embody the high-pressure lines as encased high-pressure lines to discharge the leakage via casing tubes of the high-pressure lines.

According to DE 10 2013 000 606 A1, all distributor units of the pressure accumulator system are connected to a common leakage connection line with a leakage sensor that is common for all distributor units, in order to detect a leakage quantity of the distributor units that is above a limit value. Furthermore, each distributor unit of the pressure accumulator system is assigned an individual leakage testing device designed as a visual inspection device, in order to assign the leakage to at least one distributor unit in the event that leakage is detected by way of the leakage sensor.

### SUMMARY OF THE INVENTION

One aspect of the present invention is a new type of fuel supply system of an internal combustion engine and a fuel distributor block for such a fuel supply system, with the help of which exceeding or reaching a permissible total fuel leakage of the fuel supply system in the high-pressure region can be reliably monitored or detected namely in the region of the pressure accumulator system and the or each high-pressure pump with a simple design structure.

According to one aspect of the invention, a fuel distributor block is provided between the or each low-pressure pump and the or each high-pressure pump, which can be supplied with fuel emanating from the or each low-pressure pump, emanating from which fuel can be fed to the or each high-pressure pump, and to which, emanating from the distributor units and the pumping device, a fuel leakage can be fed, wherein the fuel distributor block comprises a fuel leakage collection line for the fuel leakage fed to the fuel distributor block with a constriction or orifice, with a bypass to the constriction or orifice and with a leakage sensor in the region of the bypass, and wherein the constriction or orifice is dimensioned in such a manner that in particular when the fuel leakage conducted via the fuel leakage collection line is smaller than a limit value, all fuel leakage flows via the constriction or orifice, whereas in particular when the fuel leakage conducted via the fuel leakage collection line is greater than the limit value, a part of the fuel leakage flows via the bypass and thus via the leakage sensor. By way of this, the exceeding or reaching of a permissible total fuel leakage of the fuel supply system in the high-pressure region, namely in the region of the pressure accumulator system and the or each high-pressure pump, can be reliably monitored or detected with a simple design structure.

According to an advantageous further aspect of the invention, the constriction or orifice is provided by an assembly that is replaceably installed in the fuel leakage collection line, in particular by a grub screw, into which a bore defining the constriction or orifice is introduced. By way of this, a simple adjustment of the fuel leakage monitoring can take place during the operation of the internal combustion engine. The constriction or orifice can be easily adapted and maintained.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1: is a diagram of a fuel supply system; and

FIG. 2: is a detail of the fuel supply system of FIG. 1.

### DETAILED DESCRIPTION OF THE PRESENTLY PREFERRED EMBODIMENTS

One aspect of the invention present here relates to a fuel supply system, in particular a common-rail fuel supply system, of an internal combustion engine designed in particular as a large diesel internal combustion engine or diesel internal combustion engine of a ship and to a fuel distributor block for a fuel supply system.

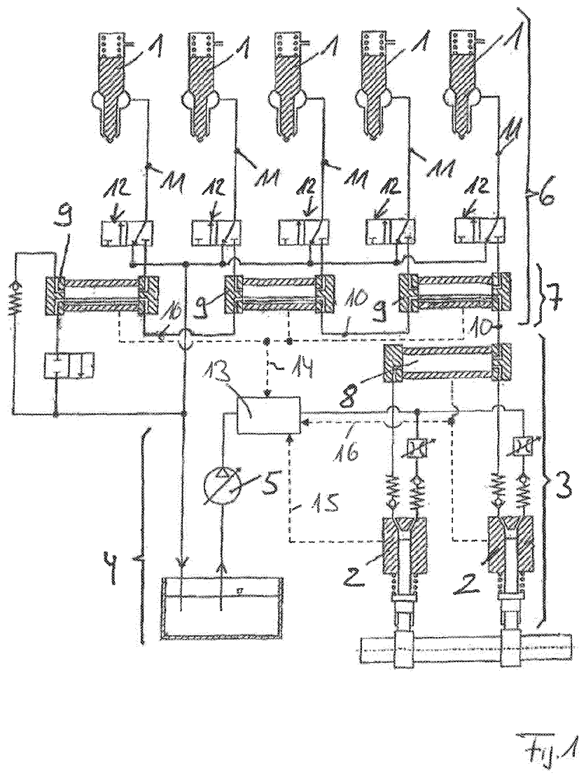

FIG. 1 shows the fundamental construction of a fuel supply system of an internal combustion engine embodied as common-rail fuel supply system, namely of a diesel internal combustion engine of a ship operated with heavy fuel oil. Accordingly, the common-rail fuel supply system of FIG. 1 comprises at least one injector 1 for each cylinder of the internal combustion engine. By way of the injectors 1, fuel is injectable into each of the cylinders of the internal combustion engine.

The common-rail fuel supply system, furthermore, comprises a pumping device 3 comprising at least one low-pressure pump 5, at least one high-pressure pump 2 and a high-pressure pump accumulator 8, to convey fuel from a low-pressure region 4 of the common-rail fuel supply system into a high-pressure region 6 of the same, wherein in the high-pressure region 6 between the pumping device 3 and the injectors 1 a pressure accumulator system 7 is provided that is permanently under high pressure.

The pressure accumulator system 7 that is permanently under high pressure, which is also referred to as common rail, comprises multiple distributor units 9. The distributor units 9 are connected to the pumping device 3 and interconnected via high-pressure lines 10 that are permanently under high pressure.

The pressure accumulator system 7, namely the distributor units 9, are, furthermore, connected to the injectors 1 by way of high-pressure lines 11 which, dependent on the injection cycle, are under high pressure at times. The high-pressure lines 11 which, dependent on the injection cycle, are under high pressure at times, which connect the injectors 1 to the distributor units 9, are assigned switching valves 12 which, dependent on the injection cycle, feed fuel to the injectors.

Between the low-pressure pump 5 of the pumping device 3 and the or each high-pressure pump 2 of the pumping device 3, a fuel distributor block 13 is connected. Emanating from the low-pressure pump 5, fuel from the low-pressure region 4 of the fuel supply system can be fed to the fuel distributor block 13. Emanating from the fuel distributor block 13, the fuel can be conducted in the direction of the or each high-pressure pump 2.

In the high-pressure region 6 of the fuel supply system, a fuel leakage can occur. FIG. 1 shows fuel leakage lines 14, 15 and 16, via which such a fuel leakage can be fed to the fuel distributor block 13.

Accordingly, a fuel leakage, which occurs in the region of the fuel distributor blocks 9 of the pressure accumulator system 7, can be fed to the fuel distributor block 13 via the fuel leakage line 14. Fuel leakage, which occurs in the region of the high-pressure pumps 2 and of the high-pressure pump accumulator 8 can be fed to the fuel distributor block 13 via the fuel leakage lines 15 and 16.

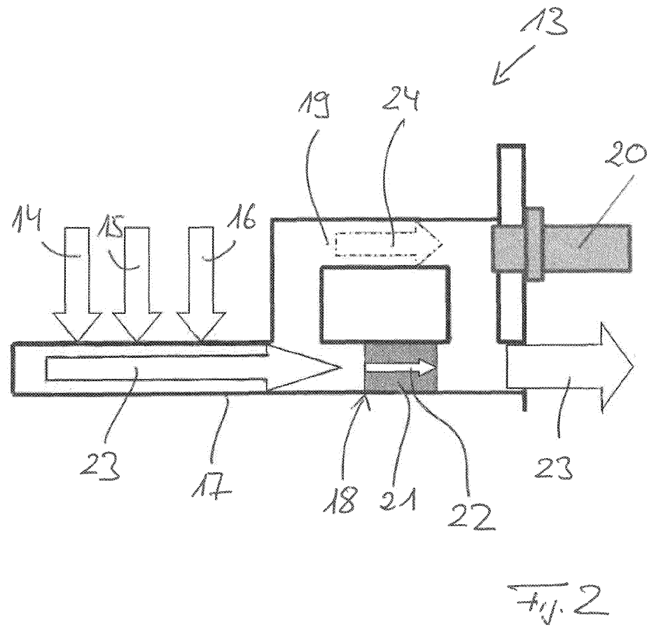

FIG. 2 shows in a schematised manner details of the fuel distributor block 13. Accordingly, the fuel distributor block 13 comprises a fuel leakage collection line 17 for the fuel leakage fed to the fuel distributor block 13 via the fuel leakage lines 14, 15, and 16.

The arrow 23 represents the fuel leakage conducted via the fuel leakage collection line 17 and collected in the region of the same, which is composed of the fuel leakage fed via the fuel leakage line 14 to the fuel distributor block 13 from the pressure accumulator system 7 and the fuel leakages fed via the fuel leakage lines 15, 16 to the fuel distributor block 13 from the high-pressure pumps 2 and the high-pressure pump accumulator 8.

The fuel leakage collection line 17 comprises a constriction or orifice 18 as well as a bypass 19 to the constriction or orifice 18, wherein the bypass 19 is assigned a leakage sensor 20.

The constriction or orifice 18 of the fuel leakage collection line 17 is dimensioned in such a manner that in particular when the fuel leakage conducted via the fuel leakage collection line 17 is smaller than a limit value, the same flows via the constriction or orifice 18.

In particular when the fuel leakage conducted via the fuel leakage collection line 17 is greater than the limit value, a part of the fuel leakage flows via the bypass 19 and thus via the leakage sensor 20 and can then be detected by the leakage sensor 20.

By way of this it can be easily and reliably detected whether the total fuel leakage in the high-pressure region 6 of the fuel supply system is smaller or greater than the limit value.

The constriction or orifice 18 is preferentially dimensioned in such a manner that via the same a so-called perspiration leakage of the fuel supply system, which is typically of the order of magnitude of 20 ml/min, can be completely discharged. When the fuel leakage is greater than such a perspiration leakage, a part of the fuel leakage, which is visualised by the arrow 24 in FIG. 2, flows via the bypass 19 so that a leakage which is above the perspiration leakage can then be detected via the leakage sensor 20. An arrow 22 visualises the leakage that can flow via the constriction or orifice 18.

According to an advantageous further development, the constriction or orifice 18 is provided by an assembly that is replaceably installed in the fuel leakage collection line 17, for example by a grub screw 21, into which a bore defining the constriction or orifice 18 is introduced. The bore has a defined diameter in order to be able to completely discharge a fuel leakage, which is smaller than the limit value, via said bore. A fuel leakage, which by contrast is greater than the limit value, can no longer be discharged via this bore so that the part of the fuel leakage that is above the limit value is conducted via the bypass 19 and the leakage sensor 20 according to the arrow 24.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A fuel supply system, configures as a common-rail fuel supply system for at least one a large diesel internal combustion engine and a diesel internal combustion engine of a ship, comprising:
a low-pressure region;
a high-pressure region;
a pumping device configured to convey fuel from the low-pressure region into the high-pressure region and comprising:
at least one low-pressure pump; and
at least one high-pressure pump;
a pressure accumulator system that is permanently under high pressure, which comprises multiple distributor units, is arranged between the pumping device and injectors assigned to cylinders;
a fuel distributor block is provided between each low-pressure pump and each high-pressure pump, to which a fuel leakage, emanating from each distributor units and the pumping device can be supplied,
wherein the fuel distributor block comprises:
a fuel leakage collection line for the fuel leakage fed to the fuel distributor block;
one of a constriction or an orifice;
a bypass to the one of the constriction or the orifice; and
a leakage sensor in a region of the bypass,
wherein the one of the constriction or the orifice is dimensioned such that when the fuel leakage conducted via the fuel leakage collection line is smaller than a limit value, all fuel leakage flows via the one of the constriction or the orifice, and when the fuel leakage conducted via the fuel leakage collection line is greater than the limit value, a part of the fuel leakage flows via the bypass and the leakage sensor.

8. The fuel supply system according to claim 7, wherein the one of the constriction or the orifice is provided by an assembly that is replaceably installed in the fuel leakage collection line.

9. The fuel supply system according to claim 8, wherein the one of the constriction or the orifice is provided by a grub screw, into which a bore defining the one of the constriction or the orifice is introduced.

10. A fuel distributor block for a fuel supply system, configured to be arranged between at least one low-pressure pump of a pumping device of the fuel supply system, and at least one high-pressure pump of the pumping device of the fuel supply system, and configured to receive a fuel leakage emanating from distributor units of the fuel supply system and of the pumping device of the fuel supply system, wherein the fuel distributor block comprises:
a fuel leakage collection line for the fuel leakage fed to the fuel distributor block;
one of a constriction and an orifice;
a bypass to the one of the constriction or the orifice; and
a leakage sensor in a region of the bypass,
wherein the one of the constriction or the orifice is dimensioned such that:
when the fuel leakage conducted via the fuel leakage collection line is smaller than a limit value, all fuel leakage flows via the constriction or orifice, and
when the fuel leakage conducted via the fuel leakage collection line is greater than the limit value, a part of the fuel leakage flows via the bypass and the leakage sensor.

11. The fuel supply system according to claim 10, wherein the one of the constriction or the orifice is provided by an assembly that is replaceably installed in the fuel leakage collection line.

12. The fuel supply system according to claim 11, wherein the one of the constriction or the orifice is provided by a grub screw, into which a bore defining the constriction or orifice is introduced.
